(19) United States
(12) Patent Application Publication
(10) Pub. No.: US 2009/0173034 A1
(43) Pub. Date: Jul. 9, 2009

(54) ELONGATE STRIP ASSEMBLY

(75) Inventor: Geoffery Arnold Woolston, Western Australia (AU)

Correspondence Address: GREENBLUM & BERNSTEIN, P.L.C., 1950 ROLAND CLARKE PLACE, RESTON, VA, 20191, US

(73) Assignee: GRAM ENGINEERING PTY LTD, New South Wales (AU)

(21) Appl. No.: 12/302,856

(22) PCT Filed: May 30, 2007
(86) PCT No.: PCT/AU2007/000755

§ 371 Date: Mar. 9, 2009

(30) Foreign Application Priority Data
May 30, 2006 (AU) 2006902894

(51) Int. Cl. E04C 2/42; B23P 11/00; B21D 47/00

(52) U.S. Cl. 52/660; 29/525.01; 29/897.31

(57) ABSTRACT

The present invention provides a two part assembly for an elongate strip such as a slat, for use in slatting or lattice-work. The assembly comprises a base member, to be fastened to a support by a fastening means (such as a rivet), and a cover member to hide the fastening means from view. This improves the appearance of the resulting structure. It also provides other advantages such as in the maintenance of the structure.

### FIELD OF THE INVENTION

The present invention relates to the field of elongate strip structures such as slatting and lattices, and the assembling of such structures.

### INCORPORATION BY REFERENCE

The entire contents of Australian Provisional Application No 2006902894 are hereby incorporated by reference.

### BACKGROUND OF THE INVENTION

Elongate strip structures such as lattices or slatting are currently used in many situations. Uses include (but are not limited to) providing structural support, to form a fence or barrier (e.g. fence palings), or merely for decorative purposes. For many such structures, appearance can be an important feature.

Typically, these structures are composed of slats—thin elongate strips each having two parallel and substantially planar faces. These slats may be constructed from various materials, including wood, plastic or metal.

Australian Patent No. 660229 describes a lattice slat structure of hollow metal slats, where a rivet is passed completely through one slat to fasten it to another slat. This leaves the rivet exposed on one side of the lattice, which can be detrimental to its appearance. This detriment is particularly likely where the structure is constructed by a “Do-It-Yourself” amateur, who may make mistakes and not consistently get the riveting process correct—accordingly, the resulting appearance may not be aesthetically pleasing.

Australian Patent No. 608417 describes a lattice slat structure of hollow plastic slats, with a resilient fastener used to connect the slats. In this slat structure, the fastener is concealed within the hollow of the slats. However, whilst this use of plastic slats and resilient fasteners improves the appearance of the slat structure, a concession is made in relation to the strength and/or durability of the structure. Furthermore, the holes in the plastic slats must necessarily be precisely aligned and located, and cannot be simply drilled in situ.

It is an object of the present invention to reduce or eliminate at least some of the disadvantages of conventional elongate strips and elongate strip structures.

### SUMMARY OF THE INVENTION

In a first aspect, the present invention accordingly provides an assembly for an elongate strip, comprising:
an elongate base member for connection to a support by a fastening means; and
an elongate cover member for attachment to and in alignment with the base member, to cover the fastening means.

The support may take many forms, including one or more other elongate strips, for example when the assembly is used as part of a lattice structure.

The fastening means may also take a variety of forms, including rivets, screws, nails or like connectors. These will typically pass through the base member, and the exposed portion will then be covered by the cover member.

Typically, the elongate strip will be a slat, and each of the members will provide one of the opposed (substantially parallel and planar) faces of the slat. However, the present invention should not be limited to slats. Furthermore, in some embodiments, the base member itself may be a slat. In that case, in use the cover member would still be positioned over the slat to cover the fastening means.

The elongate strip formed by the assembly may be hollow. The otherwise exposed parts of the fastening means may be encompassed within the hollow, therefore being hidden from view. Where the assembly is formed of metal, both of the members may be rolled metal extrusions, which cooperate to form the elongate strip.

In a second aspect, the present invention accordingly provides an elongate strip structure comprising:
a plurality of elongate base members;
fastening means fastening each base member to a support; and
a plurality of elongate cover members, each cover member attached to and in alignment with a base member, to cover the fastening means.

In a third aspect, the present invention accordingly provides a lattice structure comprising:
a plurality of elongate base members arranged in an overlying configuration;
fastening means fastening said base members together where they overly each other; and
a plurality of elongate cover members, each cover member attached to and in alignment with a base member, to cover the fastening means.

In a fourth aspect, the present invention accordingly provides a method of constructing an elongate strip structure, comprising:
fastening an elongate base member to a support with a fastening means; and
attaching an elongate cover member to and in alignment with a base member, to cover the fastening means.

In a fifth aspect, the present invention accordingly provides a method of constructing a lattice structure, comprising:
arranging a plurality of elongate base members in an overlying configuration;
fastening said base members together where they overly each other; and
attaching, to each base member, an elongate cover member in alignment with the corresponding base member, to cover the fastening means.

The cover members may be attached to the base members in any suitable way. For instance, a cover member may be clipped to a corresponding base member, may be attached by sliding it along the length of the base member, or may be snap-fitted. It is desirable that the cover member is attached to the base member without exposed fasteners.

A detailed description of one or more preferred embodiments of the invention is provided below along with accompanying figures that illustrate by way of example the principles of the invention. While the invention is described in connection with such embodiments, it should be understood that the invention is not limited to any embodiment.

For the purpose of example, numerous specific details are set forth in the following description in order to provide a thorough understanding of the present invention. However, the present invention may be practiced without some or all of these specific details. For the purpose of clarity, technical material that is known in the technical fields related to the invention has not been described in detail so that the present invention is not unnecessarily obscured.

### BRIEF DESCRIPTION OF THE DRAWINGS

An illustrative embodiment of the present invention will be discussed with reference to the accompanying drawings wherein:

FIG. 1 is a perspective view of an assembly according to an embodiment of the present invention;

FIG. 2 is a perspective view of a lattice structure according to an embodiment of the present invention;

FIG. 3 is section 3-3 of the lattice structure shown in FIG. 2;

FIG. 4 is a section of a lattice structure according to another embodiment of the present invention;

FIG. 5 is a perspective view of an elongate strip structure according to another embodiment of the present invention;

FIG. 6 is a section of an elongate strip structure according to another embodiment of the present invention; and

FIG. 7 is a perspective view of the elongate strip structure shown in FIG. 6.

### DETAILED DESCRIPTION

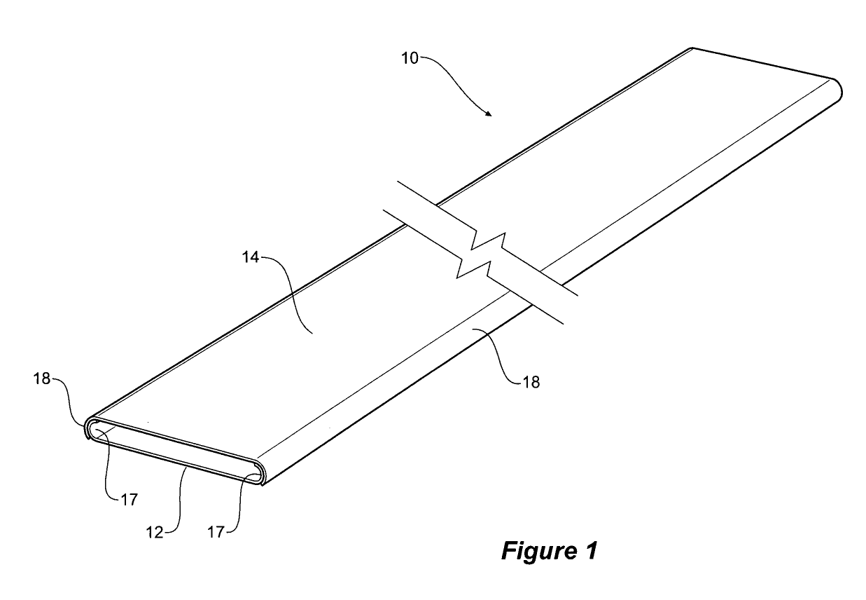

FIG. 1 shows an assembly 10 according to the present invention, having an elongate base member 12 and an elongate cover member 14. In this embodiment, both members 12, 14 are rolled metal extrusions having an approximately C-shaped cross section, each with a main portion defining a substantially flat main face, and curved portions 17, 18 along the side of the main portion. The curved portions 18 of the cover member 14 define a groove within which the base member fits.

The members 12, 14 can be clipped together to form a hollow metal slat, the main portions of each member 12, 14 defining (substantially planar and parallel) opposed flat faces of the slat. By simply clipping onto the base member 12, the cover member 14 can be attached to the base member 12 without exposed fasteners. Of course, other ways of fitting the cover member 14 to the base member 12 are encompassed within the scope of the present invention. For instance, a cover member 14 may be attached to a corresponding base member 12 by sliding it along the length of the base member 12, or may be snap-fitted. It could also be glued to the base member 12. In these ways, the cover member 14 can be attached to the base member 12 without exposed connectors. Other fastening methods such as rivets or screws are also encompassed within the scope of the present invention.

Clearly, in other embodiments, the elongate strip produced may not be a slat, and may have a circular or other shaped cross-section. However, for convenience, the following embodiments of the present invention will be described with reference to slats.

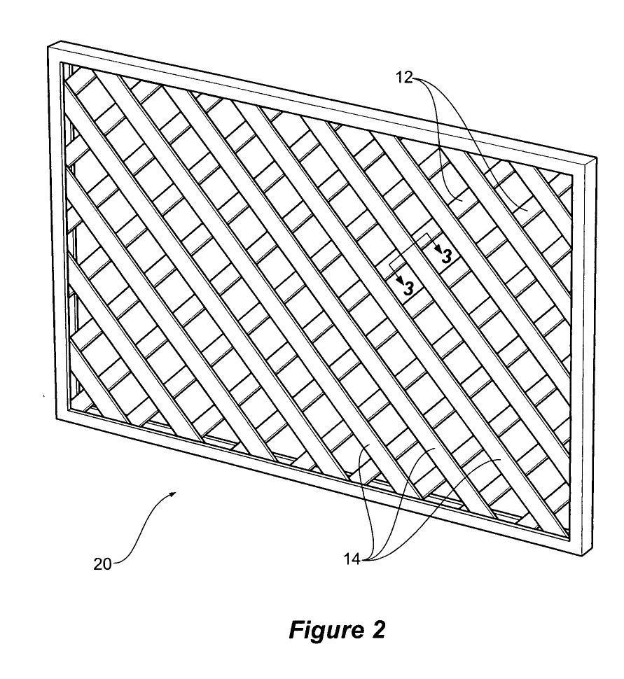

FIG. 2 shows a slat structure 20, in this case a lattice, having a plurality of slats, each formed from an assembly 10 as shown in FIG. 1. The slats are arranged in an overlying relationship. As is readily apparent, there is no visible fastening means between the slats. Rather, only the base members 12 of the slats on the far side of the lattice 20, and the cover members 14 of the slats on the near side of the lattice 20 are visible.

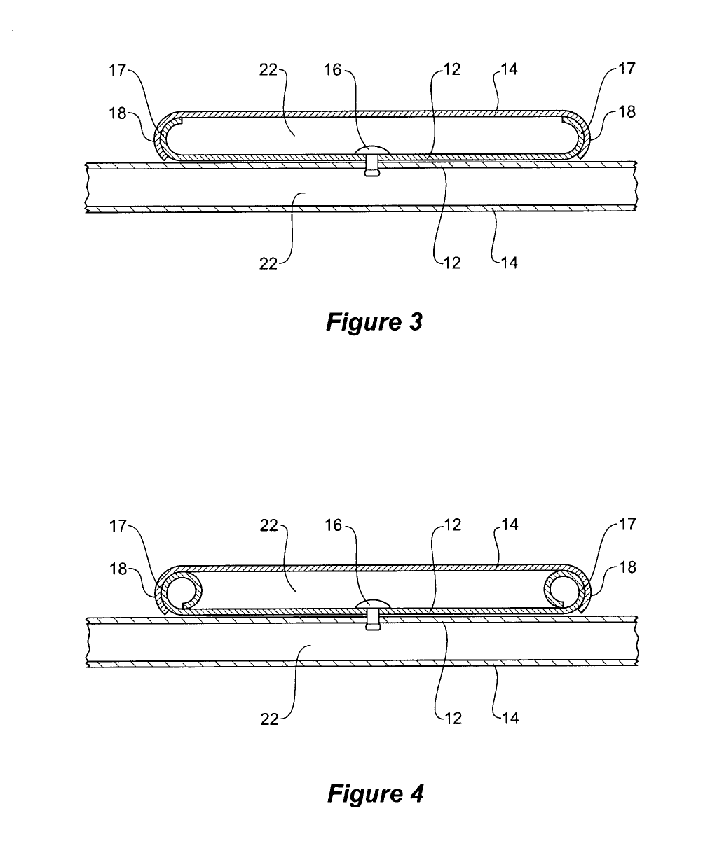

FIG. 3 shows in cross-section how this is accomplished. Where a slat overlies another slat, the fastening means, in this case a rivet 16, fastens together respective base members 12. Cover members 14 are located over the base members 12 and rivet 16, covering the rivet 16 from view on both sides. The rivet 16 is wholly contained within respective hollows 22 of the slats.

The two-part assembly 10 provides a smooth outer appearance to the structure. There are also further advantages to the present invention. For instance, the base members 12 and cover members 14 may readily be painted in different colours. This allows a structure, such as the lattice 20 shown in FIG. 2, to have different colours on each side, or to present a multi-coloured appearance on one side.

Furthermore, in some embodiments the cover members 14 may simply be replaced without removing any of the base members 12 or rivets 16. This can facilitate maintenance of the structure; if a particular slat is dented, discoloured, or otherwise blemished by exposure, the relevant cover member 14 may be replaced without needing to remove the base members 12 or rivets 16. This procedure may even be used simply to change the colour of the lattice 20 without the need to undertake a painting job.

A further potential advantage of another embodiment of the present invention may be described with reference to FIG. 4. As shown, the inwardly curved portions 17 of the base member 12 may be rolled more tightly around. This provides the resulting slat (and accordingly the resulting slat structure) with additional strength. In the embodiment shown in FIG. 3, the curved portions 17 are rolled inwardly slightly less than 180 degrees (relative to the main portion of the base member 12, which defines a face of the slat). However, the curved portions 17 may be rolled around through more than 180 degrees, and even more than 270 degrees. In the embodiment shown in FIG. 4, the curved portions 17 are shown rolled around by 360 degrees.

By rolling the curved portions 17 around further, this also makes the base member 12 look more different to the cover member 14. Accordingly, the respective pieces become easier to differentiate. This makes it easier for a user (particularly a “Do-It-Yourself” amateur) to assemble an elongate strip in accordance with the present invention—for the embodiment shown in FIG. 4, there is little likelihood that a user will confuse the base member 12 (which is for connection to a support) with the cover member 14 (which is for connection to a base member 12).

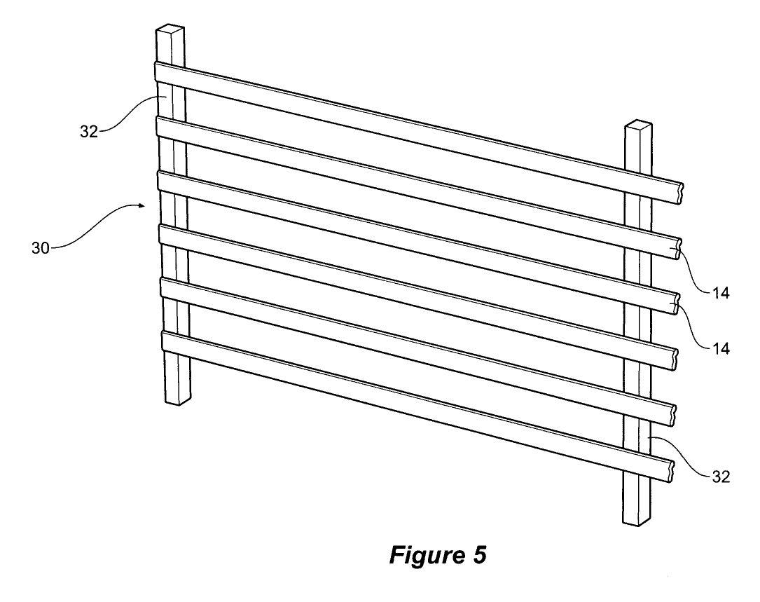

A structure according to the invention need not be a lattice structure 20 as shown in FIG. 2. Rather, the present invention may simply be used for slatting. FIG. 5 shows an alternative structure 30 composed of several parallel slats, each formed from an assembly 10 as described above. The slats run between support posts 32.

Another advantage of the present invention becomes apparent when the elongate strip structure is to be curved. Traditional slats or tubes cannot simply be bent to form a curved fence, for example, because the outer side of the elongate strip must curve at a larger radius than the inner side. If the slat or tube is bent, this results in ‘crimping’ of the elongate strip due to the different radii of the inner and outer sides.

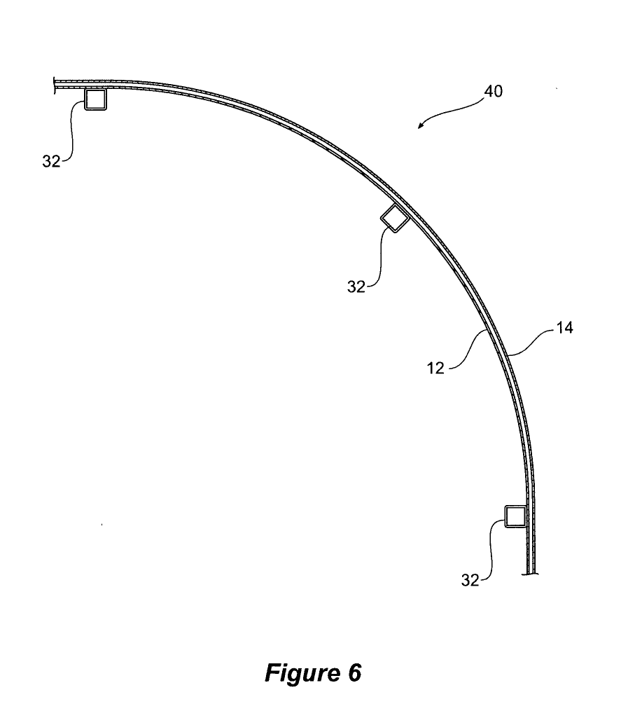

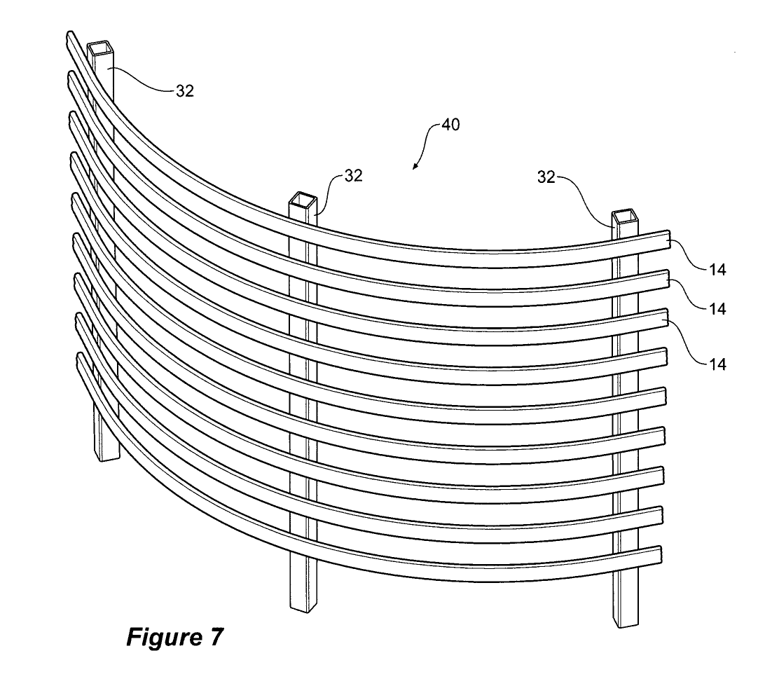

However, with an elongate strip according to an above-described embodiment of the present invention, the base member 12 and cover member 14 can simply be bent as desired. In the case of typical rolled metal extrusions, this bending may sometimes even be done by hand, without specialised tooling. If the inner member (which may be the base member 12 or cover member 14, depending on the direction of the curve) is then too long for a corresponding outer member, the inner member can then simply be cut to shorten it. FIGS. 6 and 7 show curved slat structures according to an embodiment of the present invention.

The curving or bending may be performed separately on the base member 12 and cover member 14, or may be performed whilst they are attached. If the bending is performed whilst the cover member 14 and base member 12 are attached, this ensures that the resulting curvature is the same—the members 12, 14 can then be disengaged before fastening the base member 12 to support posts 32, and the cover member 14 to the corresponding base member 12.

Although a preferred embodiment of the present invention has been described in the foregoing detailed description, it will be understood that the invention is not limited to the embodiment disclosed, but is capable of numerous rearrangements, modifications and substitutions without departing from the scope of the invention. Modifications and variations such as would be apparent to a skilled addressee are deemed within the scope of the present invention.

For example, the base members 12 and cover members 14 may be formed of various materials, such as steel, aluminium, or plastic, each of which have advantages and disadvantages that will be apparent to a skilled person. In yet other embodiments, the elongate strips may be rounded, but still exhibit the two-part assembly according to the present invention. Yet another variation would be to use screws or other fasteners to fasten the base members 12 as required. The base members and cover members could also be hinged together, allowing the elongate strip to be opened and closed to fasten it to the relevant support.

Furthermore, although the present invention has been described in relation to a specifically adapted base member 12, the invention should not be limited to such an embodiment. In particular, a cover member 14 according to the present invention may be fitted to standard slats, in accordance with the present invention.

It would also be possible to attach more than one cover member to each base member (or even vice versa). Therefore, the cover member and base member may have different lengths within the scope of the present invention.

Similarly, the types of elongate strip structures for which the invention may be used are not limited to lattices and slatting. The elongate strips may be disposed vertically and form pickets for a fence. In this event, pointed picket spears may be placed at the top of each elongate strip.

These examples are not an exhaustive list, and are only intended to be indicative of other embodiments still in accordance with the present invention.

Throughout this specification and the claims that follow unless the context requires otherwise, the words ‘comprise’ and ‘include’ and variations such as ‘comprising’ and ‘including’ will be understood to imply the inclusion of a stated integer or group of integers but not the exclusion of any other integer or group of integers.

The reference to any prior art in this specification is not, and should not be taken as, an acknowledgment or any form of suggestion that such prior art forms part of the common general knowledge.

1. An assembly for an elongate strip, comprising:
an elongate base member for connection to a support by a fastening means; and
an elongate cover member for attachment to and in alignment with the base member, to cover the fastening means.

2. An assembly as defined in claim 1, wherein the cover member is adapted for attachment to the base member without exposed connectors.

3. An assembly as defined in claim 2, wherein the cover member is adapted to be clipped to the base member.

4. An assembly as defined in claim 1, wherein the cover member comprises a groove within which the base member fits, when assembled.

5. An assembly as defined in claim 1, wherein when assembled, the elongate strip comprises a hollow between the base member and the cover member, and at least part of the fastening means is contained within the hollow.

6. An assembly as defined in claim 1, wherein the elongate strip is a slat, and when assembled, the base member and the cover member each provide one of the opposed faces of the slat.

7. An assembly as defined in claim 6, wherein the cover member and the base member each comprises:
a main portion for defining a face of the slat, and
curved portions along either side of the main portion,
wherein the curved portions of the cover member define edges of a groove within which the curved portions of the base member fit, when assembled.

8. An assembly as defined in claim 7, wherein the curved portions of the base member are curved further around than the curved portions of the cover member.

9. An assembly as defined in claim 8, wherein the curved portions of the base member curve through more than 180 degrees relative to the main portion of the base member.

10. An assembly as defined in claim 9, wherein the curved portions of the base member curve through at least 360 degrees relative to the main portion of the base member.

11. An assembly as defined in claim 1, wherein the base member has an approximately C-shaped cross section.

12. An assembly as defined in claim 1, wherein the cover member has an approximately C-shaped cross section.

13. An assembly as defined in claim 1, wherein the base member and the cover member are rolled metal extrusions.

14. An assembly as defined in claim 4, wherein the base member is a slat.

15. An elongate strip structure comprising:
a plurality of elongate base members;
fastening means fastening each base member to a support; and
a plurality of elongate cover members, each cover member attached to and in alignment with a base member, to cover the fastening means.

16. A structure as defined in claim 15, wherein each cover member is substantially the same length as the base member to which it attaches, and one cover member is attached to each base member.

17. A structure as defined in claim 15, wherein the cover members are attached to the base members without exposed fasteners.

18. A structure as defined in claim 17, wherein the cover members are adapted to be clipped to the base members.

19. A structure as defined in claim 15, wherein the cover members each comprise a groove within which a corresponding base member fits.

20. A structure as defined in claim 15, wherein hollows are defined between corresponding base members and cover members, and at least part of the fastening means are contained within the hollows.

21. A structure as defined in claim 15, wherein the base members each provide one face of a slat, and the cover members provide the opposed faces of the slats.

22. A structure as defined in claim 21, wherein each of the cover members and base members comprise:
a main portion for defining a face of the slat, and
curved portions along either side of the main portion,
wherein the curved portions of the cover member define edges of a groove within which the curved portions of the base member fit, when assembled.

23. A structure as defined in claim 22, wherein the curved portions of the base member are curved further around than the curved portions of the cover member.

24. A structure as defined in claim 23, wherein the curved portions of the base member curve through more than 180 degrees relative to the main portion of the base member.

25. A structure as defined in claim 24, wherein the curved portions of the base member curve through at least 360 degrees relative to the main portion of the base member.

26. A structure as defined in claim 15, wherein the base members have an approximately C-shaped cross section.

27. A structure as defined in claim 15, wherein the cover members have an approximately C-shaped cross section.

28. A structure as defined in claim 15, wherein the base member and the cover member are rolled metal extrusions.

29. A structure as defined in claim 15, wherein the elongate strip structure is a lattice structure, the base members are arranged in an overlying configuration, and the fastening means fastens the base members together where they overly each other.

30. A structure as defined in claim 15, wherein the base members and the cover members are curved.

31. A method of constructing an elongate strip structure, comprising:
fastening an elongate base member to a support with a fastening means; and
attaching an elongate cover member to and in alignment with a base member, to cover the fastening means.

32. A method of constructing an elongate strip structure as defined in claim 31, further comprising:
bending the base member and the cover member such that the resulting elongate strip structure is curved.

33. A method of constructing a lattice structure, comprising:
arranging a plurality of elongate base members in an overlying configuration;
fastening said base members together where they overly each other; and
attaching, to each base member, an elongate cover member in alignment with the corresponding base member, to cover the fastening means.
